(19) United States
(12) Patent Application Publication
(10) Pub. No.: US 2002/0038917 A1
(43) Pub. Date: Apr. 4, 2002

(54) Lenticular screen manufacturing process

(76) Inventor: William McKee, Tiburon, CA (US)

Correspondence Address: DERGOSITS & NOAH LLP, Suite 1150, Four Embarcadero Center, San Francisco, CA, 94111, US

(21) Appl. No.: 09/943,431

(22) Filed: Aug. 13, 2001

Related U.S. Application Data
(60) Provisional application No. 60/225,368, filed on Aug. 14, 2000.

(51) Int. Cl. B29D 11/00

(52) U.S. Cl. 264/1.36; 264/1.7; 264/1.38

(57) ABSTRACT

A method for fabricating a lenticular screen, wherein a platen is provided which has a flat surface and lenticular grooves machined into the flat surface. An optically curable material, such as a UV-curable polymer, is placed onto the platen sufficiently to fill the lenticular grooves. An optically transparent base substrate, such as glass, is then placed on top of the optically curable material. Finally, the optically curable material is irradiated through the substrate using a lamp.

### BACKGROUND OF THE INVENTION

Lenticular screens for autostereoscopic displays have been fabricated by various means, but there are new demands on such screens in this the era of the flat panel display. These corduroy-like screens and the way they way are made suffer from drawbacks for flat panel display applications. Extreme precision is required to properly match such a screen to a flat panel, such as a liquid crystal display (LCD). The screen must have a precise pitch (distance between individual lenticules), which must be maintained with uniformity over its entire surface and that pitch must be maintained for the range of operational environmental conditions. Moreover, screens that can meet such specifications can be expensive to tool and unit product costs can be high.

The art and science of lenticular screen design and fabrication has taken several directions in past decades. Applications of such screens have ranged from child's toys and novelties to scientific applications. In the last decade, point of purchase displays, commercial signage, and even medical imaging has used the technology. The granting of U.S. patents has substantially increased in the past decade and numerous related techniques have been proposed. Lenticular screens are not simple to make with the quality one needs to create a good looking display, but the technology exists and clever approaches with good attention to details will produce the required quality.

In designing lenticular screens one must not only pay particular attention to the optical formulation required, but also apply knowledge of a broad range of materials and fabrication methodology. Parameters to consider include the number of refractive interfaces and their curvature, the differences in indices between the lenticules themselves and any substrate, the thermal stability of the materials and the mechanical robustness of the resultant screen.

Designs thus far have targeted a range of material thickness from a modest several thousandths of an inch to sheets that are over a quarter of an inch. Sheets as large as 120 inches in width have been produced and the pitch has varied from a coarse 8 lenticules per inch to an innocuous 200 lenticules per inch. A reduction in the obtrusiveness of the screen structure is evidenced as the lenticular width decreases.

Fabrication can be as simple as having a single material that is embossed with the lenticular pattern or as complex as having materials stacked together and adhered in some fashion. To a great extent the choice of materials determines the behavior of the lenticular optics whether or not bonded to a substrate. Moreover, for a flat panel display, the precise alignment of the lenticules to display pixels calls for extremely good registration accuracy. This requires exactness of pitch and homogeneity over the entire extent of the screen, exactness of curvature of each and every lenticule, and dimensional stability so that the juxtaposition of lenticule and pixel is assured and held constant.

Some of the stability requirements can be addressed if the displayed information is firmly a part of the lenticular substrate, which for hardcopy occurs when the reverse side has printing applied directly to it. There are more problems when one attempts to hold the lenticular screen in close contact with a separate printed sheet. Movement here, in the slightest amounts, will cause a degradation of image quality and diminish or ruin the overall results. A supremely difficult situation occurs when one attempts projection and thereby places the information onto the rear of the lenticular screen. While it is obvious that the rear surface now must be of a diffusion surface, it is also important that the projection not impart any optical distortions. Such geometric distortions would spoil the alignment of screen and image elements.

Several methodologies for fabrication of lenticular screens will be reviewed.

Method One

A sheet of thermoplastic material is placed within a heated chamber in close contact with a metallic platen. The platen's surface is machined with the reverse or negative shape of the desired lenticular surface detail. The chamber is brought to a temperature that will cause the material to become plastic. With a measured pressure a flat surface bears against the plastic and causes it to fill the voids in the machined surface. After an appropriate time the platen and plastic material, still in contact, are removed from the chamber and allowed to cool. A lenticular sheet or screen is formed in the material because of the impression left on its surface.

With regard to the equipment, materials, and facility required for this approach, the heated chamber is an oven whose temperature range must be sufficient for all thermoplastics one wishes to use in the process. A temperature of up to 225 degrees Centigrade may be required although most work will be done in the range of 125 to 150 degrees. This oven is fitted with an insulated door and, to apply the pressure, a hydraulic ram with a capacity of tons. The pressure required is about 100 psi (pounds per square inch). Therefore a 10″×10″ screen will require five tons of pressure. It is possible to lower the pressure requirements as the temperature is elevated but only within a limited range. Workers must be careful and be equipped to handle hot platens that weigh up to 65 lbs.

The machined platen or mold may be a slab of aluminum of an area large enough to impress the largest desired screen. It will have a thickness of about ½ inch. The platen must be machined to flatness of +/−0.006 inches across the face and of a #4, or better, finish. An overcoating of copper is then applied to a minimum thickness of 0.015 inches. The machined negative lenticular surface is thus constructed with a special diamond tipped lathe bit of high precision to cut the platen. The cutting surface must be round to within tight tolerances and it must be handled with great care due to its brittle nature. The design of this tool requires specifying the temperature used during the fabrication process and the type of material to be used. One must consider the index of refraction and thermal coefficients of expansion because these have a strong influence on the final focal length of the lenticules. Checking with a microscope is required at numerous times during the preparation.

Once the surface finish is approved, the surface is chrome “flashed” to insure a hardness to withstand numerous cycles. The resulting object is an optical master surface of high luster and beauty.

In constructing the “sandwich” that is placed into the oven one begins with this platen. Atop the platen is the thermoplastic sheet. This sheet may have a pressure sensitive adhesive coated on the opposite side with a release liner above that. Over this plastic sheet one places a kraft paper and then a finely finished pressure plate of thin cross-section, perhaps as little as ⅛ inch, and of mirror quality finish. Stainless steel may be effectively used for this part, the purpose of which is to even out the pressure gradients that may occur within the sandwich due to variations in thermal conductivity, uneven pressures, or warping in any of the other components.

As the proper technique is worked out so that the resultant lenticular screen has both the optical quality and thickness required, the optimal processing time can established. It is possible to stack a number of separate sandwiches in the oven simultaneously and thus reduce the time of processing per sheet.

If a particular thickness of lenticular sheet is desired, it may be necessary to provide machined stop blocks that permit the sandwich to be squeezed up to a certain point. One problem with this approach is that if a pressure sensitive adhesive is used to adhere the sheet to a glass or plastic substrate, the adhesive will allow movement over time and this can spoil the image quality.

The lenticular sheet can be affixed to a host plate, of glass or plastic for example, if a host plate is required. Adhesive versus material compatibility requires study. Note that if glass is used the thermal expansion of the glass is a critical factor in setting up the screen parameters and fabrication tooling. One must also plan the method of alignment and laying down the part as well as the selection of an adhesive. A roller system can be employed, a vacuum jig, or perhaps a simple placement and fasteners of some type. The alignment is extremely critical and it would be preferable if the adhesive allowed some movement to accommodate a final adjustment after it is applied.

This method can be precise and repeatable with a minimum of rejects but is slow and labor intensive and finished product cost is high. This method necessarily limits the size of the resultant lenticular screen to a size that can be accommodated within the oven and by the size of the hydraulic press. The upper limit for this process would be screens of around two feet by two feet.

Method Two

This method uses a different approach to impress plastic with a lenticular pattern and is known as calendering. A roller system is employed with a spool of plastic material placed onto a holding support. A system of rollers fitted to a frame and driven by a variable speed motor acts to move the plastic through the system. Once inserted into the web on a feed-roller the plastic sheet ends up on a take-up roller at the opposite end. The plastic material may have a pressure sensitive adhesive (PSA) on the reverse side that is covered by a release liner.

The roller used to impress the lenticular surface onto the plastic material is machined on a lathe with great precision. The roller is made up of the same kind of material used in Method One except that it is now a cylinder rather than a flat platen. The same type of tool is used for the machining operation of this roller as is used for the flat platen. The difference is that the precision machining of the roller must begin with the aluminum “round” surfacing, then the plating, next a surface preparation utilizing a normal high precision machine turning operation, and then finally the cutting of the grooves and subsequent chrome flashing.

The calendering machine has a precision adjustable roller with a surface that is used to apply pressure to the web material as it moves onto the grooved roller. The precision with which one adjusts this pressure roller determines the final thickness of the lenticular screen. Just at the intersection of the two rollers, and just before the plastic material is introduced between them, a solvent is applied to the surface to be embossed or calendered. The combination of web speed, pressure, room temperature, type of plastic, and solvent will determine the end product.

One advantage of this process is that a higher speed of production is possible than with Method One. In addition, if one wishes to have a sheet of great length it is easily accomplished. The width of the roller, obviously, determines the width of the sheet. The use of a heater/dryer at the output end cures the finished material.

The type of material and solvents used in the process will also have an impact on the design of the lenticular roller because the typical solvent surface softening is accompanied by a swelling of the material. This swollen surface is the one being impressed onto the roller and thus the roller design must seek to compensate for the subsequent material shrinkage occurring as the solvent is released from the material. If the web speed is either too fast or too slow, it is possible to distort the material upon its exit from the lenticular roller.

Method Three

This method is similar to Method Two but a liquid co-polymer is applied to a moving web of plastic material instead of a solvent to soften the surface. The material of Method Two must be of a thermoset type whereas for Method Three the surface material must be of the thermoplastic type. The laying on of the surface material is done immediately prior to the introduction to the lenticular roller which is of a chill roller design. The chill roller is fitted with a water flow capability through its center. This enables it to maintain a controlled temperature to solidify the surface material while it is in contact with the roller surface. The roller's machined negative lenticular grooves are the same size as the desired end result since there is no dimensional change in the solvent release method.

One must be cautious in the selection of the materials used for both the web and surfacing materials since adhesion is required. This may be improved by a sizing or a surfacing process of the web material prior to the introduction of the surface material. Choice of materials here also has an impact on roller design since there may be differences in the indices of refraction of the materials. The thickness of the surface material can be adjusted by the pressure roller spacing.

The thickness of the web material must be carefully controlled since few thermoset materials retain optical clarity at increased thickness. Thus, it may be required to use a thicker surface layer or the addition of a third filler layer between the web base and the surface material may be required. This can become a difficult to solve problem and preparation and planning phases may be prolonged.

Method Four

This method utilizes a plate similar to that of Method One with the significant difference that the material is not introduced at elevated temperatures but is a liquid that is poured onto the surface at room temperature. It can therefore be described as a casting method. The platen is designed for use at ambient temperature. Flatness is still of critical importance. The thickness of the cast lenticular sheet is determined by mechanical stops used to space the top follow-plate above the base platen. If an extraordinarily thick sheet is planned, it is possible to utilize a follow-sheet made of an optically clear material to which the cast material adheres upon curing.

One problem with this method is the possible entrapment of air pockets within the casting. A procedure for introduction of the follow-plate plate must be developed to preclude air entrapment.

We have described four methods for manufacturing lenticular sheets and these methods have their advantages and disadvantages. Since it is our desire to have a lenticular surface that is dimensionally stable, the lenticules themselves must be coated on glass and not on plastic as is, generally speaking, the case for the methods described above.

### SUMMARY OF THE INVENTION

The present invention is a method for fabricating a lenticular screen. First, a platen is provided which has a flat surface and lenticular grooves machined into the flat surface. Then, an optically curable material, such as a ultraviolet-curable polymer, is placed onto the platen sufficiently to fill the lenticular grooves. An optically transparent base substrate is then placed on top of the optically curable material. Finally, the optically curable material is irradiated through the substrate using a lamp.

Preferably, the platen includes shims or raised edges which extend above the flat surface and function to define the thickness of the lenticular sheet. Further, the platen is preferably made from a material which resists adhesion to the optically curable material, such as a fluoropolymer.

### BRIEF DESCRIPTION OF THE DRAWINGS

FIG. 1 shows a cross section of the materials used in the fabrication of lenticular sheets in accord with the disclosed invention.

FIG. 2 shows a cross section of a lenticular screen created by the manufacturing process described in this disclosure.

### DETAILED DESCRIPTION OF THE INVENTION

The specific purpose of our disclosure is to describe the art of making a lenticular screen to be used in conjunction with a flat panel display. The lenticular screen we describe and the flat panel display are both made of glass. Accordingly the coefficient of thermal expansion of the lenticular screen and the flat panel display will be similar. Our experiments have shown that a lenticular sheet or screen made entirely of plastic will not have the required dimensional stability for a flat panel application. Over time, as temperature changes occur, there will be a loss of alignment between the lenticules and the display screen's image, or corresponding pixels. Therefore an entirely plastic lenticular screen, with thermal expansion characteristics different from glass, cannot be used in our application.

It is best if a manufacturing technique can be devised which intrinsically coats the lenticules onto a glass substrate, and in this way achieve greater dimensional stability with temperature variations. By this means we can obviate the need to combine the plastic lenticules with the glass substrate as a separate step. Such a step involves additional cost and higher rejection rates for cosmetic defects that include entrapped air bubbles or particulate matter. We also seek a fabrication method that has extremely high precision with accurately reproduced lenticules that has a consistency within a sheet and from sheet to sheet with regard to pitch and optical quality.

The inventive manufacturing technique is related to that described in Method Four above. However, there are some important differences and improvements in our art compared to prior art, as will now be enumerated.

The initial cost to create the facility is low compared to the prior art methods given above. This includes the initial tooling, equipment, ongoing costs, and maintenance. In addition, for a high precision part, the piece part costs are low.

Our method is fast, precise and requires a minimum of support equipment in a properly designed facility. Compared with the methods described as prior art, it will take up the least space.

Our method lends itself to fast re-tooling for various pitches and focal lengths with a minimum of expense.

There is no excessive use of solvents, high temperatures, high-pressure, or heavy tooling, and that is better for the employees' health and the environment.

Moreover, the process intrinsically creates a completed lenticular screen in a one-step process, without the requirement that the lenticular screen be laminated to a substrate in a separate operation. This is important because the process innately creates lenticules bonded to a dimensionally stable substrate that matches the thermal expansion characteristics of the flat panel display to which the lenticular screen will be affixed.

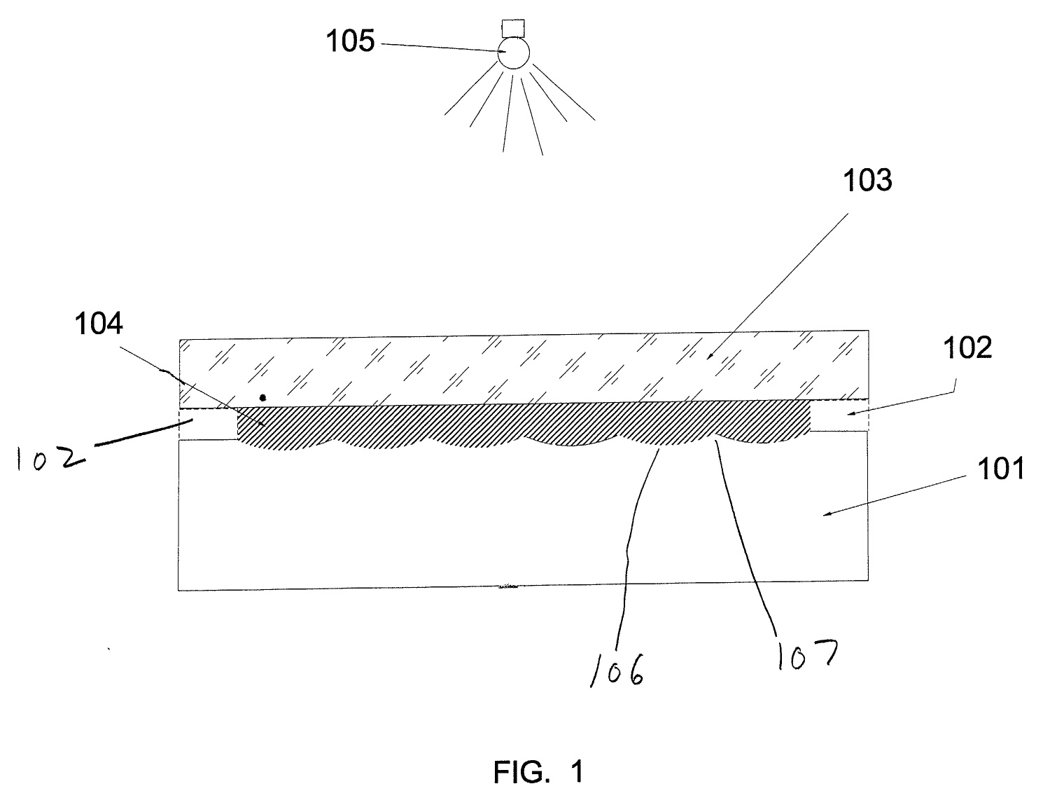

The invention will now be described in more detail. FIG. 1 shows a cross sectional layout of the manufacturing technique of our preferred embodiment. The master platen 101, that has the lenticular master surface, 106, is placed on a flat working surface (not shown). This platen 101, can be fabricated with raised edges, 102, which serve to accurately maintain a predetermined thickness of ultraviolet (UV) curable (or other) optical material. An alternative is a precision shim, which may be used in place of fabricating the platen with a fixed raised edges, 102. The master platen's machined surface 106, is prepared with a surface to which the UV curable material will not adhere, possibly a Teflon-like floropolymer. The UV curable material, 104, illustrated by means of crosshatching, is poured onto the master platen 101, in sufficient quantity to fill the machined grooves 106, and up to the level of the edge ridges 107, of the platen.

The base substrate, 103, which may be made of glass, plastic, or any suitable transparent substance, is then placed onto the lenticular material 104. The material of this base substrate 103, must pass the UV wavelengths required to activate the polymer/epoxy's curing process. Care must be taken to insure that cleanliness is maintained and that no air bubbles are present in material 104. Upon final placement of substrate 103, and inspection, the UV lamp, 105, is activated in order to irradiate the UV curable material (through substrate 103).

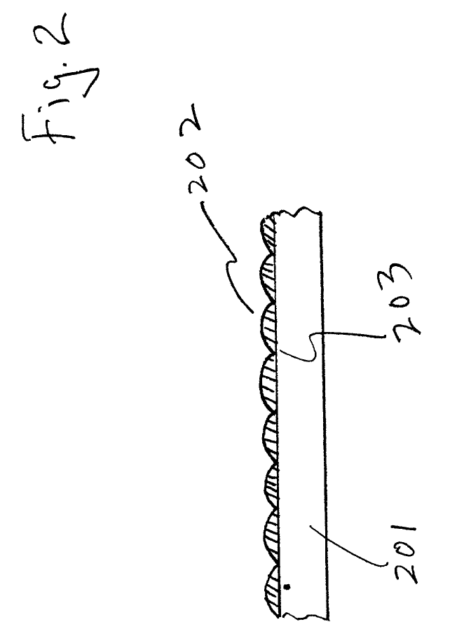

FIG. 2 shows a cross section of a completed lenticular screen manufactured by the process described here. We see the curved portion of the cylindrical lenticules themselves, 202, further indicated by means of crosshatching, deposited on the substrate material 201, which we prefer to be made of glass. Only the topmost sectors or curved portion of the lenticules need be cast onto the substrate, and after the UV curing the excess material 104 is squeezed or forced out of the space between platen and substrate. In FIG. 2 we show what occurs when lenticule boundary or edge ridges (107 in FIG. 1 and 203 in FIG. 2) make contact with the substrate (103 or 201). It should be obvious to one skilled in the art that by adjusting shims or fixed raised offsetting edges 102, the ridges, 107, can either make contact with the substrate 102, or additional offset can be provided.

As noted, the process uses an optically clear polymer that cures in place with UV radiation. This gives the operator time to allow for all the caution and care prior to setting or curing of the material. One can consider this to be a casting approach but, to our way of thinking, it is a casting on-command process with curing occurring at will.

There are optically clear photoset-polymers as well as UV curable epoxies on the market that can also be used. While such materials are typically used for other purposes such as encapsulation, potting, bonding, and fixturing, and so on, some of them are useful in this process. UV curable polymers such as the Hemon Manufacturing Ultrabond series and the UV curable epoxies such as the Epoxies Etc... 60-7010, among others, provide the capability of fabricating the lenticular surfaces in the manner disclosed herein.

Our method requires cleanliness and environmental control of temperature, humidity, and illumination but it does not require a secondary operation to apply the lenticular sheet to the glass plate substrate since the substrate is used as the follow-plate plate in the process. This simplifies the manufacturing process and contributes to a quality product at the lowest possible cost even when one considers the high precision that is required. Our teaching produces the highest precision possible since all work is accomplished in a well-regulated environment with the lenticules directly deposited on the glass surface. It is the glass surface that contributes to the dimensional stability of the screen in the user's environment. The lenticular screen will be coupled to a flat panel display that is also fabricated from glass and the two will have similar coefficients of thermal expansion. A change in dimension of one will be accompanied by a change in dimension of the other and the juxtaposition of lenticule and pixel will be guaranteed.

Our process allows for large sheets to be fabricated—on the order of three by four feet, or with care, even larger. The limitations are determined by the sheet thickness desired, the follow-plate material used and hold-off mechanisms. The hold-off mechanism keeps the central portion of the follow-plate plate at the same spacing as the edges during the cure. It is obvious that precise spacing is required, and for the smaller parts we can rely on edge holding alone. For larger ones we need a vacuum harness arrangement with a precise laser level.

Fabrication at room temperature is possible, and this is an advantage compared with several of the prior art techniques and reduces cost and complexity. Moreover, the process allows tweaking of the pitch of the screens by careful temperature and humidity control, which can serve to fine-tune the pitch of the screens.

Although metal molds cut with diamond tools will produce good results, a non-metallic cast mold may be used in this process. Thus the mold cutting tool no longer needs to be diamond tipped, and this saves costs.

In considering initial and ongoing costs, the quantity of production planned and the space considerations, the embodiment we have described here has advantages, as one skilled in the art will recognize. One skilled in the art will also recognize that variations in the process in no way detract from the generality of the art taught here. For example, non-UV-curing materials might well be used but the basic process remains the same.

1. A fabrication method for a lenticular screen, comprising:
providing a platen having a flat surface and lenticular grooves machined into the flat surface,
pouring a optically curable material onto the platen sufficiently to fill the machined grooves,
placing a optically transparent base substrate on top of the optically curable material, and
irradiating the optically curable material through the substrate using a lamp.

2. A fabrication method as in claim 1, wherein the platen further comprises raised edges extending above the flat surface.

3. A fabrication method as in claim 1, wherein the platen further comprises shims coupled to the platen and extending above the flat surface.

4. A fabrication method as in claim 1, wherein the platen is made from a material which resists adhesion to the optically curable material.

5. A fabrication method as in claim 4, wherein the platen is made from a fluoropolymer.

6. A fabrication method as in claim 1, wherein the optically curable material is a UV curable polymer.

7. A fabrication method as in claim 1, wherein the optically transparent base substrate is glass.

8. A fabrication method for a lenticular screen, comprising:
providing a platen having a flat surface and lenticular grooves machined into the flat surface,
providing edges extending above and around a periphery of the flat surface the platen,
pouring a UV curable polymer onto the platen sufficiently to fill the machined grooves,
placing a glass substrate on top of the UV curable polymer, and
irradiating the UV curable polymer through the glass substrate using a UV lamp.
